(19) United States
(12) Patent Application Publication
(10) Pub. No.: US 2026/0167887 A1
(43) Pub. Date: Jun. 18, 2026

(54) Sliding Coating for Composite Components and Method for Its Manufacture

(71) Applicant: Robert Bosch GmbH, Stuttgart (DE)

(72) Inventors: Alexander Buck, Kirchheim Unter Teck (DE); Arne Kamphausen, Neu-Ulm (DE); Henrik Helmlinger, Nagold (DE); Markus Benjamin Wilms, Glatten (DE); Olof Schmitz, Oberndorf (DE); Philipp Sitzler, Emfpingen (DE); Thilo Strobel, Sulz (DE); Zuzana Zuber, Horb Am Neckar (DE)

(21) Appl. No.: 19/419,426

(22) Filed: Dec. 15, 2025

(30) Foreign Application Priority Data
Dec. 16, 2024 (DE) 10 2024 137 958.8

(51) Int. Cl. C10M 103/04; B23K 26/342; B23P 15/00; C10N 40/02; C10N 50/00; C22C 9/02

(52) U.S. Cl. CPC C10M 103/04; B23K 26/342; B23P 15/003; C22C 9/02; C10M 2201/053; C10N 2040/02; C10N 2050/023

(57) ABSTRACT

In a method for manufacturing a sliding coating for a composite component, an adhesive layer on the side of the base body, made of a lead- and bismuth-free bronze, is first applied to a solid, iron-based bearing material of a base body by deposition welding. An outer sliding layer made of a lead-free and bismuth-containing bronze is then applied to the adhesive layer by deposition welding.

This application claims priority under 35 U.S.C. § 119 to application no. DE 10 2024 137 958.8, filed on Dec. 16, 2024 in Germany, the disclosure of which is incorporated herein by reference in its entirety.

### FIELD

The present disclosure relates to a composite component with a bronze sliding coating and a method of manufacturing the same. Bronze is an alloy with 60% copper and a further alloy component, e.g. tin.

### BACKGROUND

It is known from the prior art to apply lead-containing bronze as a sliding coating on iron-based components or base bodies. In order to achieve high layer adhesion, these materials are applied to the substrate in a molten state. In general, the longer the bronze remains in a molten state, the stronger the layer adhesion becomes. Such sliding coatings (and composite components coated with such sliding coatings) cannot meet upcoming regulatory requirements such as RoHS and REACH and will be prohibited by law in the near future, at least in Germany.

Bismuth is a possible substitute for lead. Like lead, this is a solid lubricant that can improve the sliding properties of bronze. When applied in the molten state, however, the solidification process must take place much faster with bismuth bronze than with lead bronze, as the bismuth can otherwise accumulate in the structure at the grain boundaries, which in turn leads to embrittlement of the bronze.

As described in EP 2 292 805 B1, this process can be delayed by adding sulfur. The material obtained in this way can be produced in a casting process like lead bronzes without becoming brittle.

U.S. Pat. No. 7,906,222 B2 discloses a bronze sliding coating, whereby bismuth is proposed as a substitute for lead. The bismuth is distributed unevenly in the layer, so that there are regions with a lot and regions with little bismuth.

Furthermore, WO 2019/072995 A1 mentions bismuth-containing bronze as a sliding coating on the cylinder drum of an axial piston machine, among other things. The sliding coating has several layers, which are applied sequentially one after the other using laser metal deposition (LMD).

The disadvantage of the latter prior art is that when applying bismuth-containing bronze by laser cladding, it is not possible to produce a sliding coating without defects while maintaining high layer adhesion. The reason for this is that, in order to ensure good layer adhesion at the interface with the iron-based bearing material (steel or cast iron), the temperature should remain as high as possible for as long as possible. On the other hand, the energy input is limited by the relatively low boiling temperature of bismuth (of 1560° C.). If the energy input is too high, the bismuth evaporates and defects occur in the sliding coating.

The task of the present disclosure is therefore to avoid this disadvantage.

This task is solved by a composite component with the features disclosed herein and by a method with the features disclosed below.

### SUMMARY

The composite component according to the disclosure has a solid iron-based base body (in particular made of steel or cast iron) and a sliding coating thereon. The sliding coating is double-layered; more precisely, it has an adhesive layer on the side of the base body made of lead- and bismuth-free bronze and an outer sliding layer made of lead-free and bismuth-containing bronze. Both layers are built up by means of deposition welding.

For good layer adhesion, it was possible to maintain the highest possible temperature for as long as possible at the interface with the iron-based bearing material (steel or cast iron) of the base body during deposition welding, even though the energy input was limited by the relatively low boiling point of bismuth (1560° C.) in the sliding layer. The energy input for the bismuth was therefore limited in such a way that it did not evaporate and no defects were created in the sliding coating. The sliding coating of the composite component according to the disclosure was therefore manufactured by deposition welding and has a sliding coating without defects and with high layer adhesion.

In other words, the advantage of this composite component is that the adhesive layer can be applied with optimum parameters in terms of layer adhesion and the sliding layer with optimum parameters in terms of sliding properties. A compromise is no longer necessary, so that high coating adhesion and good sliding properties can be achieved at the same time.

The material of the adhesive layer is selected so that it ensures good bonding to the base body on the one hand, and on the other hand also forms a good connection with the (outer) sliding layer while still exhibiting high cavitation resistance.

The material of the sliding layer is selected so that it has good sliding properties and bonds easily with the lower adhesive layer at the same time.

Preferably, the composite component according to the disclosure is used as the cylinder drum of an axial piston machine.

The sliding coating is extremely durable and abrasion-resistant even without sulfur, so that this component can be dispensed with.

The adhesive layer is preferably so thick that no bismuth diffuses from the sliding layer to the bearing material (steel or cast iron) during deposition welding of the sliding layer and, if necessary, subsequent gas nitrocarburizing of the composite component. The thickness of the adhesive layer manufactured during the deposition welding process is preferably between 50 μm and 500 μm.

The bismuth-containing, sliding-optimized sliding layer is designed in such a way that a full-surface sliding layer is still reliably present even after machining.

Preferably, the sliding layer has a smooth sliding surface that is machined (turning, milling, grinding, etc.) after deposition welding. In the case of the cylinder drum, there is a flat or spherical circular cylindrical sliding surface towards the distribution plate.

The thickness of the sliding layer manufactured during deposition welding and preferably after machining is preferably between 0.1 mm and 1.0 mm.

Preferably, the composite component is thermally and/or chemically treated, e.g. nitrided or gas-nitrocarburized. This is a heat treatment to increase the surface hardness by increasing the carbon and/or nitrogen content on the ferrous material surface. Carbon and nitrogen contents are preferably increased. In the case of the cylinder drum, for example, the corresponding layer is only relevant for the cylinder bores, whereby it does not interfere in any other way. As the adhesive layer does not contain any bismuth, the good adhesion of the layer is maintained even after heat treatment. In bismuth-containing alloys of the prior art, however, there is a risk that bismuth will accumulate at the transition between the iron-based bearing material (steel or cast iron) and the bronze when the bronze is reheated, thereby reducing the layer adhesion.

To improve the mechanical properties of the sliding coating despite or after heat treatment, it is preferred if the adhesive layer and/or the sliding layer contain less than 4% (preferably 1-3%) nickel. In a particularly preferred embodiment, both the adhesive layer and the sliding layer contain the same percentage of nickel.

The method according to the disclosure is used for manufacturing a sliding coating, in particular of a composite component as disclosed. According to the disclosure, an adhesive layer on the side of the base body, made of a lead- and bismuth-free bronze, is first applied to a solid, iron-based bearing material of a base body by means of deposition welding. An outer sliding layer made of a lead-free and bismuth-containing bronze is then applied to the adhesive layer by means of deposition welding.

For good layer adhesion, it is possible to maintain the highest possible temperature for as long as possible at the interface with the iron-based bearing material (steel or cast iron) of the base body during deposition welding, even though the energy input was limited by the relatively low boiling point of bismuth (1560° C.) in the sliding layer. The energy input for the bismuth is therefore limited so that it is not vaporized and no defects occur in the sliding coating. With the method according to the disclosure, it is possible to produce a composite component with a sliding coating without defects and at the same time with high layer adhesion.

In other words, the advantage of this method is that the adhesive layer is applied with optimum parameters in terms of layer adhesion and the sliding layer with optimum parameters in terms of sliding properties. A compromise is no longer necessary, so that high coating adhesion and good sliding properties can be achieved at the same time.

Due to the higher feed speeds that are possible when applying the adhesive and sliding layers using the method according to the disclosure, the sliding coating according to the disclosure can be applied by deposition welding in the same time as a single layer according to the prior art.

With sliding coatings containing bismuth throughout, which are prior art, there is a risk that bismuth will accumulate at the transition between the bearing material and the bronze when the bronze is reheated, thereby reducing the adhesion of the coating. In contrast, if a particular type of further development of the method is preferred, the entire composite component can undergo thermal and/or chemical treatment.

For example, nitriding or gas nitrocarburizing can be carried out on the entire composite component, e.g., 2.5 to 3.5 hours at 570 to 590° C. Since the adhesive layer does not contain bismuth, the good layer adhesion is retained even after gas nitrocarburizing. In the case of the cylinder drum, the corresponding layer is only relevant for the cylinder bores, whereby it does not interfere in any other way.

In a particularly preferred further development of the method, a smooth sliding surface is manufactured. For this purpose, the sliding layer is machined (turning, milling, grinding, etc.) after deposition welding. In the case of the cylinder drum, a circular cylindrical sliding surface that is flat or spherical towards a distribution plate is manufactured.

In the case of the latter two embodiments of the process, gas nitrocarburizing takes place before the sliding layer is processed. Preferably, gas nitrocarburizing is carried out after deposition welding of the adhesive layer.

Preferably, the (power-related) energy input during deposition welding of the adhesive layer is higher than the corresponding energy input during deposition welding of the sliding layer. This ensures good adhesion of the adhesive layer to the bearing material of the base body, wherein no pores are formed by the evaporation of bismuth during the production of the sliding layer.

When applying the layers using the method according to the disclosure, in particular using laser deposition welding (Laser Metal Deposition, LMD), the following improvements can be achieved compared to a single bismuth-containing layer:

The bismuth-free adhesive layer according to the disclosure offers the following advantages:
Significantly higher layer adhesion: +50% to +100% compared to single layer
Significantly fewer defects (pores, cracks)
Higher laser output possible for laser deposition welding: +50% compared to single layer
Higher (up to four times) feed speed possible compared to single layer

The bismuth-containing sliding layer according to the disclosure offers the following advantages:
Significantly higher layer adhesion to adhesive layer, as welded joint (-intermixing) with adhesive layer due to design as bronze-bronze pairing.
Avoidance of defects/pores due to evaporating bismuth, as reduced energy density in the molten bath is possible
Higher feed speeds possible compared to single layer

### BRIEF DESCRIPTION OF THE DRAWINGS

FIG. 1 shows a view of a composite component designed as a cylinder drum with a sliding coating according to an exemplary embodiment of the present disclosure;

FIG. 2 shows a schematic cross-section of the sliding coating from FIG. 1 after an intermediate manufacturing step;

FIG. 3 shows a schematic cross-section through the sliding coating from FIG. 2 after machining

FIG. 4 shows an exemplary embodiment of the method according to the disclosure.

### DETAILED DESCRIPTION

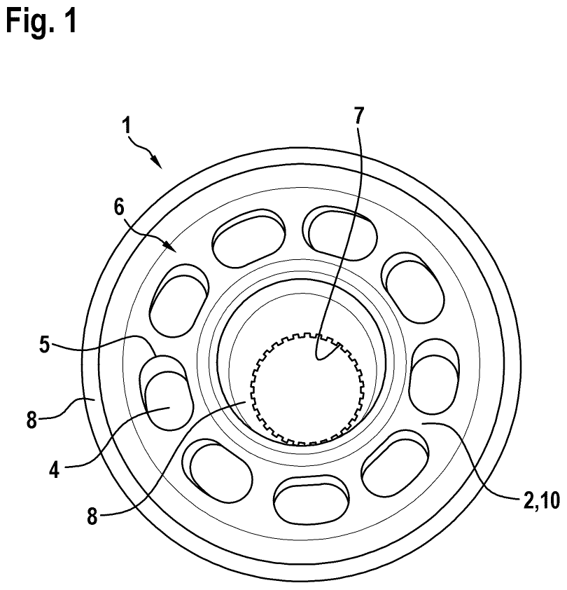

FIG. 1 shows a view of a composite component designed as a cylinder drum 1 with a sliding coating 2 according to an exemplary embodiment of the present disclosure;

The cylinder drum 1 is connected, in a rotationally fixed manner, via an internal gearing 8 to a shaft arranged perpendicular to the plane of the drawing, which extends through a central recess in the cylinder drum 1.

The cylinder drum 1 has several (nine in the exemplary embodiment shown) cylinder bores inside it, which are arranged perpendicular to the drawing plane and in each of which a corresponding piston is guided (both not shown). Each cylinder bore is connected to the end face 6 of the cylinder drum 1 shown via an orifice 4.

The flat or spherical end face 6 of the cylinder drum 1 is pressed tightly against a distributor disk (not shown) of a higher-level axial piston machine. During operation of the axial piston machine, the cylinder drum 1 rotates together with the shaft. The end face 6 must slide relative to the stationary distributor disk so that the orifices 4 are alternately connected to a high-pressure kidney and a low-pressure kidney of the distributor disk.

For this reason, the sliding coating 2 is applied to the end face 6 of the cylinder drum 1. As the sliding coating 2 has two layers, only the outer so-called sliding layer 10 can be seen in FIG. 1.

The sliding coating 2 is circular and completely surrounds the recess of the end face 6, through which the shaft extends. The sliding coating 2 also fully covers all orifices 4. Due to the rotation of the cylinder drum 1 relative to the stationary distributor disk, the sliding coating 2 has a particularly high mechanical wear-promoting load at the edges 5 in the direction of rotation.

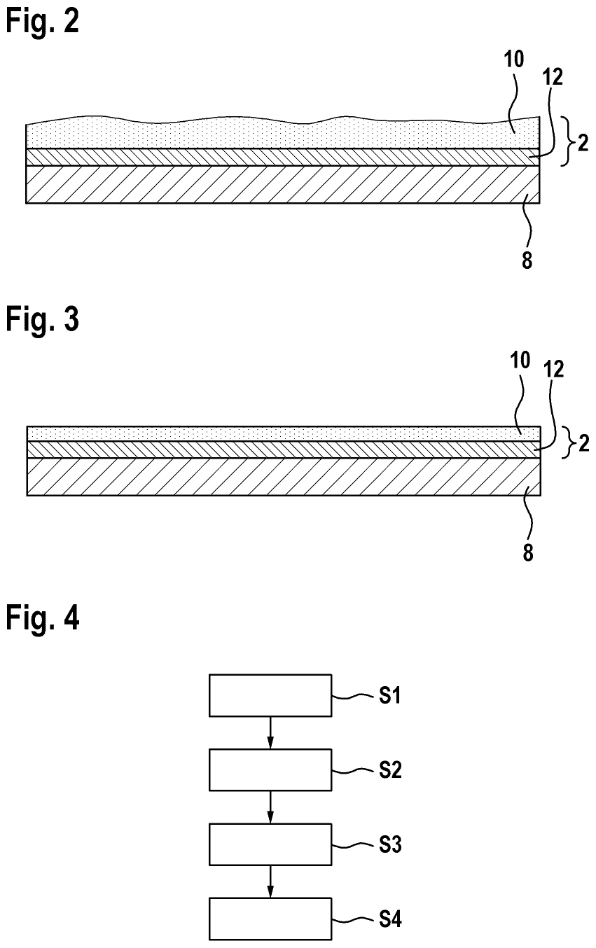

FIG. 2 shows a schematic cross-section of the sliding coating 2 from FIG. 1 after an intermediate manufacturing step. An adhesive layer 12 was first applied to the steel or cast base body 8 of the cylinder drum 1 by laser depositing welding. The sliding layer 10 was then applied to the adhesive layer 12 by laser deposition welding.

FIG. 3 shows a schematic cross-section of the sliding coating 2 from FIG. 2 after machining. More specifically, the sliding layer 10 was machined by grinding, milling, or rotating

The adhesive layer 12 on the side of the base body consists of a bismuth-free bronze with the following composition:

| | |
|---|---|
| Sn: | 7%-14% |
| Ni: | 0%-4% |
| Cu: | Residual |

The adhesive layer 12 has a layer thickness of 50 μm-500 μm. Preferred variant: 400 μm layer thickness.

The (outer) sliding layer consists of a bismuth bronze with nickel with the following composition:

| | |
|---|---|
| Sn: | 7%-14% |
| Bi: | 1%-8% |
| Ni: | 0%-4% |
| Cu: | Residual |

The sliding layer 10 has a layer thickness of 0.1 mm-1.0 mm. Preferred variant 0.4 mm layer thickness.

The compositions of the sliding and adhesive layers 10 and 12 are selected so that they are as similar as possible. This ensures good mixing of the two bronze-containing layers 10 and 12, so that the sliding layer 10 can be applied to the adhesive layer 12 easily and with good adhesion.

FIG. 4 shows an exemplary embodiment of the method according to the disclosure. It has the steps of applying the adhesive layer 12 by means of laser deposition welding S1 and then applying the sliding layer 10 by means of laser deposition welding S2 and then gas nitrocarburizing the base body 8 with the aim of hardening the cylinder bores.

Finally, the machining step S4 of the sliding layer 10 takes place in the form of grinding, milling or rotating.

In the sliding layer 10, the addition of bismuth and preferably nickel is necessary for good tribological performance. Bismuth in particular acts as a solid lubricant (similar to lead in the previous bronze), while nickel also improves the mechanical properties. The addition of nickel also has the advantage that the structural transformation during the subsequent gas nitrocarburizing S3 is minimized. In the case of nickel-free bismuth bronze such as CuSn10Bi3, a gas nitrocarburizing process S3 after laser deposition welding S1, S2 results in the formation of a new microstructure in which the bismuth is deposited at the grain boundaries. As a result, cracks can form more easily at these weak points during operation of the composite component, i.e. in particular when the cylinder drum 1 rotates relative to the distributor plate, i.e. in particular at its leading edges 5, which then migrate very quickly along the bismuth at the grain boundaries. However, if the bismuth is spherical and finely distributed in the structure, this does not happen.

The adhesive layer 12 does not contain bismuth, which would impair adhesion by accumulating at the interface between the bearing material and the bronze. This can sometimes happen directly during coating S1, S2. A subsequent heat treatment S3, such as the nitriding process or the three-hour gas nitrocarburizing process for cylinder drum 1, in which the bismuth is liquefied again, increases the deposition of bismuth at the transition.

On the other hand, the bismuth in the adhesive layer 12 limits the maximum possible energy input during laser deposition welding S1, as it has a relatively low boiling temperature and pores and defects would form in the adhesive layer 12 during vaporization. For good (diffusion) bonding to the base body 8, however, it is necessary for the liquid bronze to remain in contact with the base body 8 for as long as possible at the highest possible temperature.

According to the disclosure, this conflict of objectives is resolved with the bismuth-free bronze in the adhesive layer 12. This makes it possible to realize high energy densities in the process. This creates a good diffusion bond with the base body 8, without the risk of voids forming in the layer due to evaporating elements. The formation of a bismuth interface between the base body 8 and the bronze is also excluded.

### LIST OF REFERENCE NUMBERS

1 Composite component/Cylinder drum
2 Sliding coating
4 Orifice
5 Edge
6 end face
8 Internal gearing
10 Sliding layer
12 Adhesive layer
S1 Step 1/deposition welding on the adhesive layer
S2 Step 2/deposition welding of the sliding layer
S3 Step 3/Thermal and/or chemical treatment
S4 Step 4/Processing the sliding layer

1. A composite component comprising:
a solid iron-based base body; and
a sliding coating, which has:
an adhesive layer on a side of the base body made of a lead- and bismuth-free bronze; and
an outer sliding layer made of a lead-free and bismuth-containing bronze,
wherein the adhesive layer and the sliding layer are applied by means of deposition welding.

2. The composite component according to claim 1, wherein a thickness of the adhesive layer is between 50 μm and 500 μm.

3. The composite component according to claim 1, wherein the sliding layer is between 0.1 mm and 1.0 mm thick.

4. The composite component according to claim 1, wherein the sliding layer has a smooth sliding surface which is produced by machining.

5. The composite component according to claim 1, wherein the composite component is thermally and/or chemically treated.

6. The composite component according to claim 1, wherein at least one of the adhesive layer and the sliding layer contains less than 4% nickel.

7. The composite component according to claim 6, wherein the at least one of the adhesive layer and the sliding layer contains 1-3% nickel.

8. A method for manufacturing a sliding coating of a composite component, comprising:
applying, by deposition welding, an adhesive layer on a side of a solid, iron-based bearing material of a base body of the composite component, the adhesive layer being made of a lead- and bismuth-free bronze is applied to a base body;
after applying the adhesive layer, applying an outer sliding layer made of a lead-free and bismuth-containing bronze to the adhesive layer by deposition welding.

9. The method according to claim 8, further comprising:
thermally and/or chemically treating the composite component.

10. The method according to claim 8, further comprising:
machining the sliding layer after deposition welding so as to produce a smooth sliding surface of the sliding layer.

11. The method according to claim 10, further comprising:
heat treating the composite component before the machining of the sliding layer.

12. The method according to claim 8, wherein an energy input during deposition welding of the adhesive layer is higher than a corresponding energy input during deposition welding of the sliding layer.
